(19) United States
(12) Patent Application Publication
(10) Pub. No.: US 2004/0217612 A1
(43) Pub. Date: Nov. 4, 2004

(54) Gripping claw for tubular goods

(76) Inventor: Per Slettedal, Ovrebo (NO)

Correspondence Address: NIXON & VANDERHYE, PC, 1100 N GLEBE ROAD, 8TH FLOOR, ARLINGTON, VA, 22201-4714, US

(21) Appl. No.: 10/469,354

(22) PCT Filed: Mar. 15, 2002
(86) PCT No.: PCT/NO02/00109

(30) Foreign Application Priority Data
Mar. 15, 2001 (NO) 20011324

(51) Int. Cl. B25J 15/08

(52) U.S. Cl. 294/88; 294/115

(57) ABSTRACT

A gripping apparatus (1) for tubular goods is disclosed. The apparatus comprises two in respect of each other pivotable jaws (1a, 1b) and a working cylinder (8) that effects motion of the jaws (1a, 1b) in respect of a stationary housing (2). A counter block (7) is arranged between the jaws (1a, 1b) in the housing (2), and each jaw is by forced motion movably arranged in respect of the counter block (7). The moveable forced motion causes axial forth and back displacement simultaneous with the opening/closing of the jaws (1a, 1b). The working cylinder (8) is connected to each jaw (1a, 1b) via respective articulated connection forming pivot axis for the pivotable jaws.

The present invention relates to a gripping apparatus for tubular goods, comprising two in respect of each other pivotable jaws and a working cylinder that effects motion of the jaws in respect of a stationary housing.

A gripping apparatus of this nature is utilised in connection with manipulation of tubular goods on board a drilling rig where the tubulars are to be run into or retrieved from a drilled well. The tubular goods can be drill pipes, production tubes, casings, drill collars etc. The external tube dimension can be in the range of 2⅞″ to 9¾″, and preferably the one and same gripping apparatus shall be able to span this dimensional range.

The gripping apparatus is to be able to grip a pipe and hold on this both horizontally and vertically, and the heaviest pipe can weight 10 tons. Having a safety factor of 2, the gripping apparatus must be able to carry a load equivalent to 20 tons. For a particular use the total width of the gripping apparatus can not exceed 350 mm, and the overall length need to be less than 800 mm. This is to enable the gripping apparatus to be introduced in between the pipes in a pipe rack, such as an existing pipe rack of the finger board type. The fact is that the larger the gripping apparatus is the fewer pipes can be stored per square metre. In addition, the gripping apparatus needs to have that particular quality that only one pipe at the time is gripped when the pipes are closely stacked after each other by a distance approximately 20 mm apart.

These small construction dimensions, together with the said preconditions, form basis for the present invention. The mentioned measures and dimensions, however, are to be considered as examples and not as any limitation.

According to the present invention, a gripping apparatus of the introductorily disclosed nature is provided, which is distinguished in that a counter block is arranged between the jaws in the housing, each jaw being by forced motion movably arranged in respect of the counter block, said moveable forced motion causes axial forth and back displacement simultaneous with the opening/closing of the jaws, and the working cylinder is connected to each jaw via respective articulated connection forming pivot axis for the pivotable jaws.

In a preferred embodiment, the movable forced motion for the opening/closing of the jaws is provided by respective guiding means that are stationary arranged within the housing. Each jaw is then movable between the counter block and one respective guiding means.

Suitably, spring means are urging the jaws compliantly from each other.

Each jaw is preferably externally designed with guiding surfaces co-acting with each guiding means. The guiding means can be in the form of a roller device.

Each jaw may have arranged at least one gripping die covering a part of the internal surface thereof.

The working cylinder may suitably be interconnected to respective jaw via a yoke. The yoke can be rigidly fixed to the working cylinder, and the articulated connection to respective jaw is spaced apart from the working cylinder.

Preferably can the housing include, in the direction of the tubular goods, projecting control limbs in pairs for catching of the tubular into the gripping apparatus.

Other and further objects, features and advantages will appear from the following description of one for the time being preferred embodiment of the invention, which is given for the purpose of description, without thereby being limiting, and given in context with the appended drawings where:

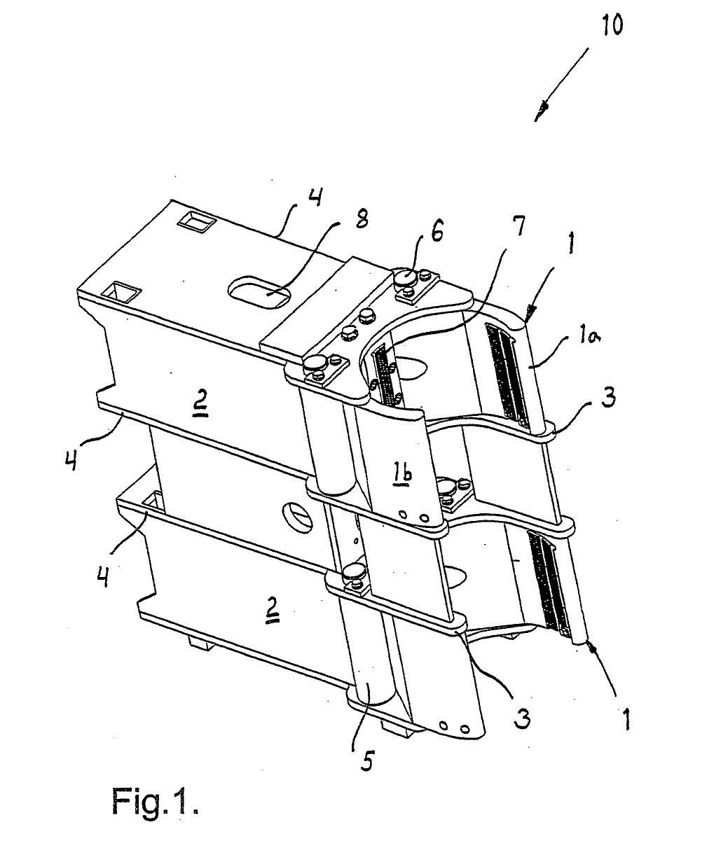

FIG. 1 shows in perspective view the gripping apparatus in opened position ready to grip a tubular,

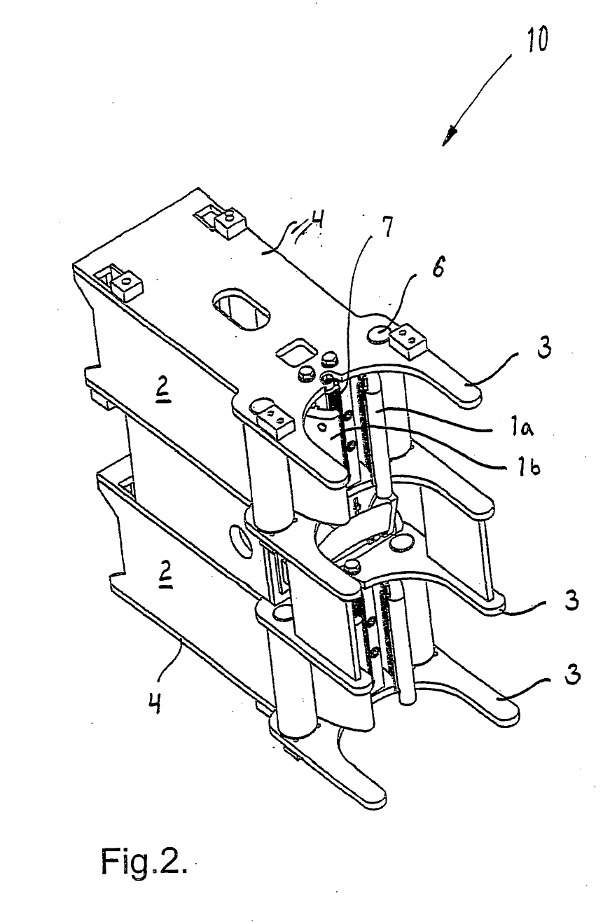

FIG. 2 shows in perspective view the gripping apparatus in closed position,

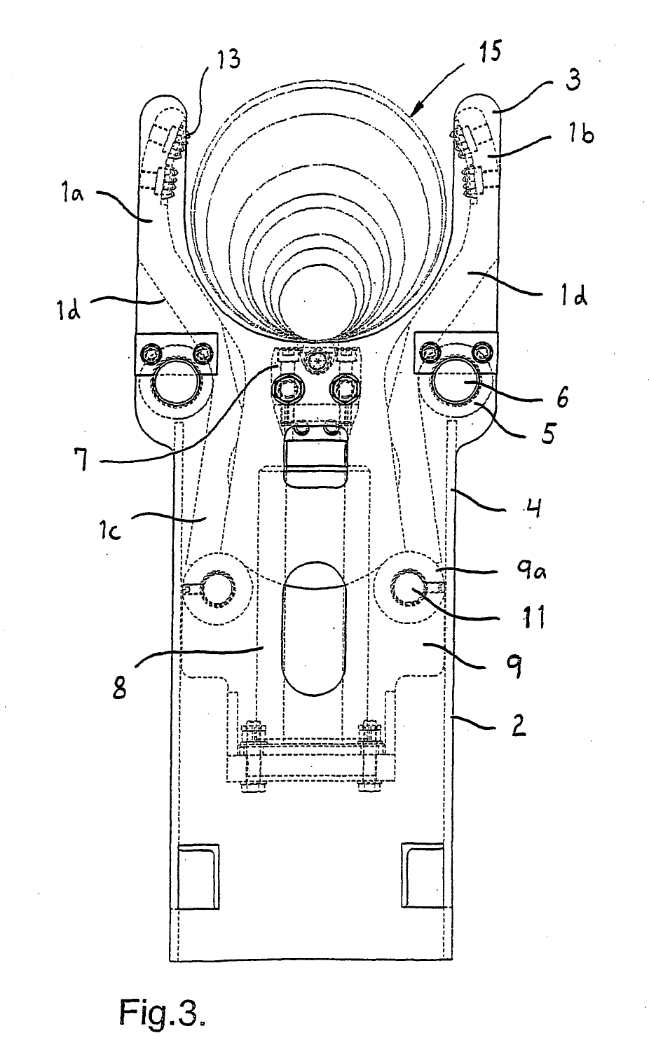

FIG. 3 shows the gripping apparatus from above in wide open position for gripping about a pipe of largest possible pipe dimension, such as a well casing,

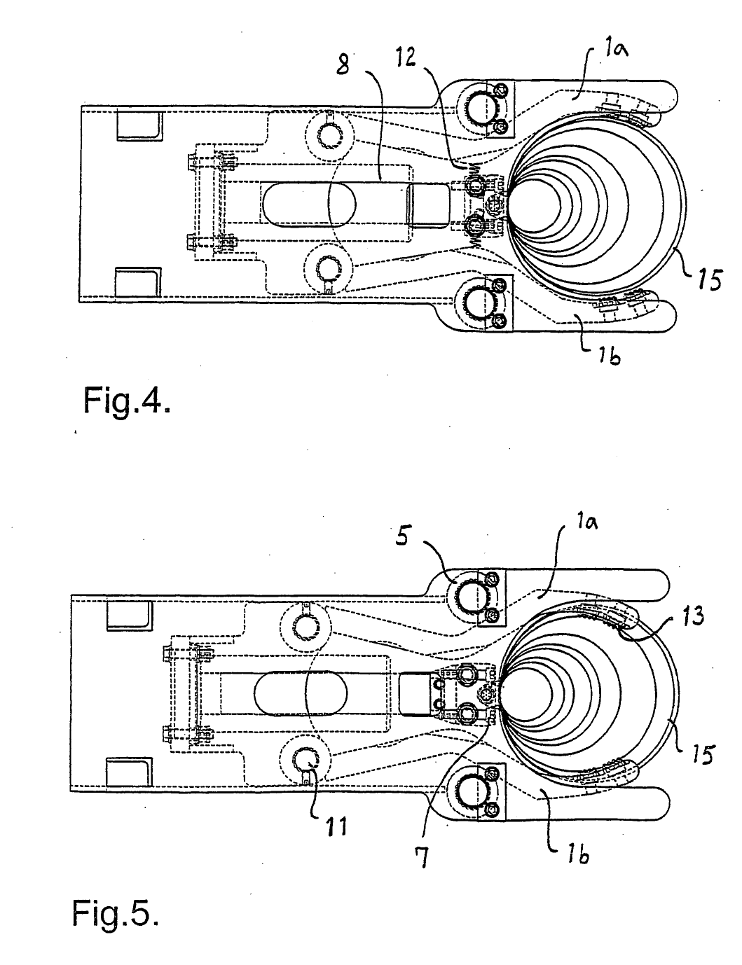

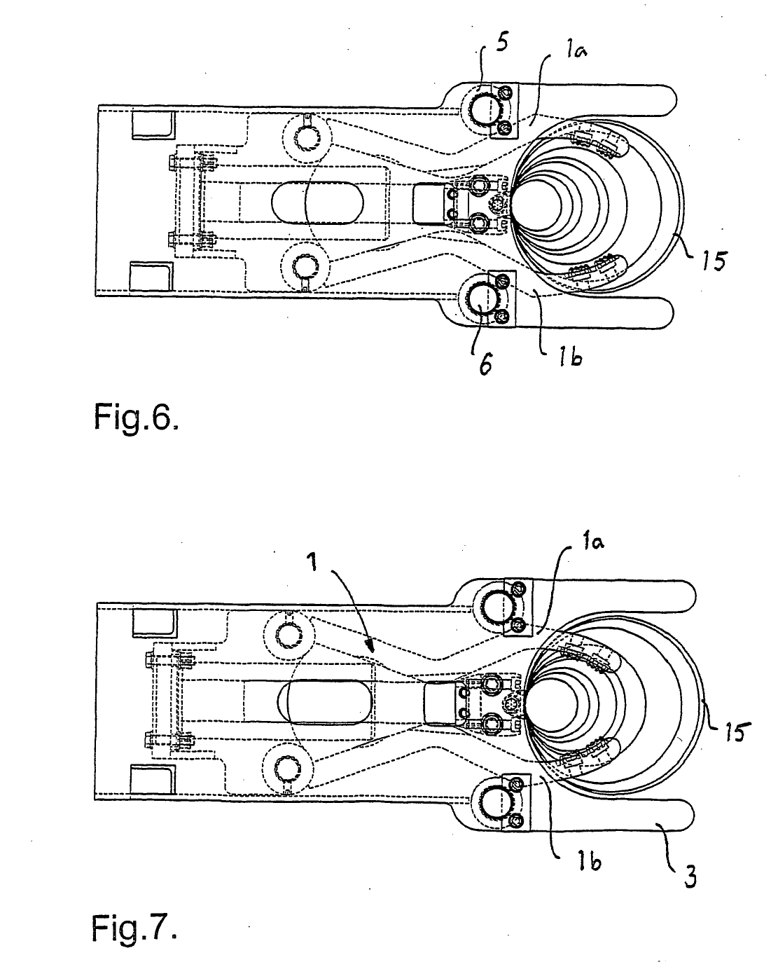

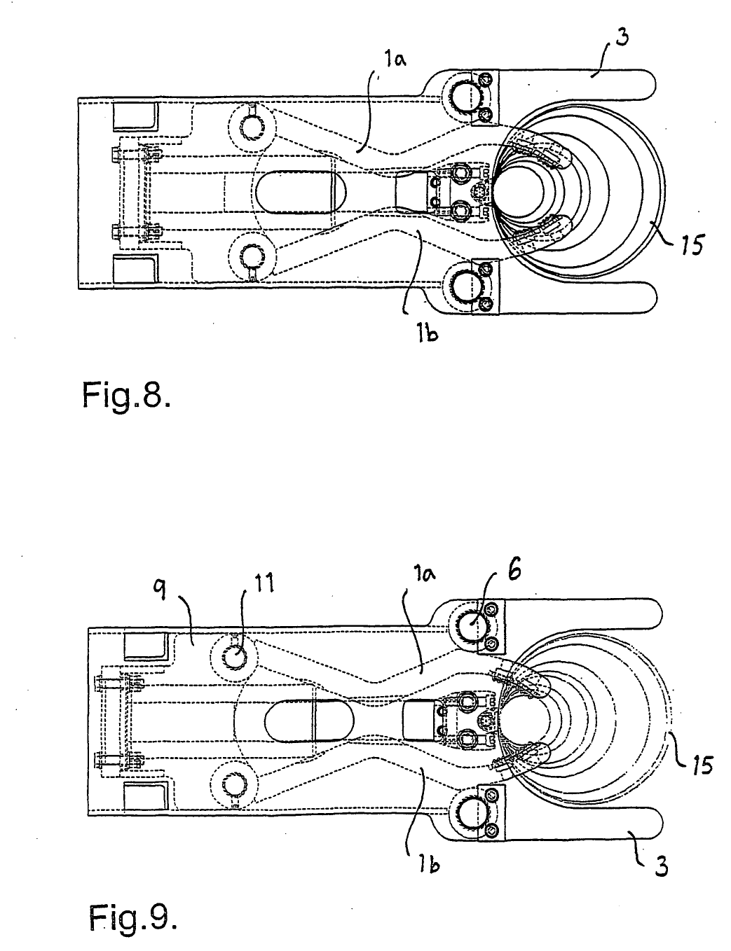

FIG. 4-9 show the gripping apparatus from above for grasp around a pipe of decreasingly pipe dimension.

Reference is first made to FIGS. 1 and 2 that show an assembled gripping apparatus 10 consisting of two separate per se identical gripping claws 1 arranged in a common housing 2. The housing 2 comprises a number of projecting limbs 3 that are stationary relative to the housing 2. The projecting limbs 3 point toward the pipe that is to be grasped and the limbs 3 assist in guiding the pipe into the gripping apparatus 10. The projecting limbs 3 are extensions of a plate 4 that forms the top, respectively the bottom of each gripping claw 1. The assembled gripping apparatus 10, as shown in FIGS. 1 and 2, has four such plates 4 and eight projecting limbs 3.

Guiding means 5 in the form of rollers that are supported in an axle shaft 6 fixed to respective pair of plates 4, are arranged between the plates 4. Between the guiding means 5 also a counter block 7 is provided, against which the pipe is brought to bear during a grasping sequence. The counter block 7 is further arranged between the respective pair of plates 4 and is rigidly and stable secured to the plates 4.

The gripping claw 1 is slidably arranged in the housing 2 and consequently between respective pair of plates 4. A working cylinder 8 is in one end thereof fixed to the housing 2, for example to the counter block 7. The other end of the working cylinder 8 is fixed to the gripping claw 1 via a yoke 9. When the working cylinder 8 is extended, the yoke 9 is pulled therewith. The yoke 9 is connected to the respective jaws 1a, 1b of the gripping claw 1.

Each jaw 1a, 1b is articulated connected to each side of the yoke 9. The articulated connection is shown as an axle 11 that extend through the end of respective jaw 1a, 1b and lugs 9a on the yoke 9. The longitudinal axis through the shaft 11 thus will act as a pivotal axis for the jaws 1a, 1b.

Each jaw 1a, 1b is rigid and includes a substantially straight portion 1c extending out from the yoke 9. Then the jaws 1a, 1b pass further on between the counter block 7 and a guiding means 5 and makes an angle outwardly relative to the said straight portion and from thereon describes a claw configuration that is able to embrace a pipe. Each jaw 1a, 1b has an external bearing surface 1d which is designed for co-operation with the guiding means 5, or the roller. Spring means 12 may be provided either directly between the jaws 1a, 1b, or between the counter block 7 and respective jaw 1a, 1b so that the jaws 1a, 1b are continuously urged apart.

The jaws 1a, 1b may preferably, at the internal surfaces thereof, be arranged with replaceable inserts, such as gripping dies 13 or similar friction forming means for solid grasp about and secure fixation of the pipe. The counter block 7 may be provided with similar inserts having properly friction forming properties.

A sensor element can be arranged internally of the ripping claw 1. The sensor element may preferably be arranged close to the counter block 7. The sensor element is able to register when a pipe is catched within the gripping claw 1 and is brought to bear against the counter block 7. The gripping claw 1 will then be ready to make a grasp around the pipe.

A sequence of how the gripping claw 1 is operated and controlled will now be described with reference to FIG. 3-9. In FIG. 4-9 it is schematically illustrated a number of actual pipe dimensions that one and same gripping claw 1 is able to grasp, keep fixed and manipulate. Generally the pipes are given the same reference number 15 since the same operation is needed to grasp a pipe of large or small dimension, it is only the motion of the jaws 1a, 1b that are different Thus FIG. 4 shows a grasp about a pipe 15 of largest dimension, FIG. 5 a grasp about a pipe 15 of smaller pipe dimension etc. and finally FIG. 9 a grasp about a pipe 15 of smallest pipe dimension.

When a pipe 15 is to be picked out from a pipe storage, for example a pipe rack having vertically arranged pipes depending from a finger board (not shown), the gripping claw 1, in opened position, is introduced into the pipe rack. The pipes are hanging in rows with close proximity after each other, like 20 mm, and the rows are also close adjacent to each other.

The gripping claw 1 is extended until the sensor element register that the pipe 15 is located within the open gripping claw 1 and bears against the counter block 7. Then the working cylinder 8 is activated and is pushing the yoke outwards and pulls the respective jaws 1a, 1b therewith. The housing 2 including the counter block 7 remain stationary. When the jaws 1a, 1b are pulled out, the external abutment surfaces thereof will co-operate with respective guiding means 5, which, due to the oblique angle outwards, urges the jaws 1a, 1b towards each other and the jaws 1a, 1b close around the pipe and gradually forces the pipe against the counter block 7 and make solid grasp about the pipe. Next the gripping claw 1 and the pipe are manoeuvred out from the pipe rack for transfer to predetermined location.

When the pipe has arrived at the destination and is secured in position, the working cylinder 8 is once again activated, but in opposite direction. Thus the yoke 9 and the jaws 1a, 1b are pushed back in opposite direction within the housing 2 and the gripping claw 1 is reopened and releases the pipe.

An operation in reverse order has to be performed in order to fetch a pipe 15 and bring it back to the finger board in the pipe rack.

1. A gripping (1) for tubular goods, comprising two in respect of each other pivotable jaws (1a, 1b) and a working cylinder (8) that effects motion of the jaws (1a, 1b) relative to a stationary housing (2), characterised in that a counter block (7) for engagement with a tubular member (15), said second end is located rearward of the counter block (7) and includes a pivot axis enabling pivotal motion of the jaw (1a, 1b) about said pivot axis, each jaw (1a, 1b), and jaw guiding means (5) providing forced motion of the jaws during axially forth and back displacement of the working cylinder (8) enabling opening/closing of the jaws (1a, 1b) respectively.

2. The gripping claw according to claim 1, characterised in that each jaw guiding means (5) is stationary arranged within the houdsing (2).

3. The gripping claw according to claim 2, characterised in that each jaw (1a, 1b) is movable between the counter block (7) and one respective guiding means (5).

4. The gripping claw according to claim 1, characterised in that spring means are urging the jaws (1a, 1b) compliantly from each other.

5. The gripping claw according to claim, characterised in that each jaw (1a, 1b) preferably is externally designed with guiding surfaces (1d) co-acting with each guiding means (5).

6. The gripping claw according to claim 1, characterised in that the guiding means (5) comprises a roller device.

7. The gripping claw to claim 1, characterised in that each jaw (1a, 1b) is provided with at least one gripping die (13) on a part of the internal surface thereof.

8. The gripping claw according to claim 1, characterised in that the working cylinder (8) is interconnected to respective jaw (1a, 1b) via a yoke (9).

9. The gripping claw according to claim 8, characterised in that the yoke (9) is rigidly fixed to the working cylinder (8), and the articulated connective jaw (1a, 1b) is spaced apart from the working cylinder (8).

10. The gripping claw according to claim 1, characterised in that the housing (2) includes, in the direction of the tubular member (15), projecting control limbs (3) in pairs for catching the tubular member (15) into the gripping claw (1).
